(19) United States
(12) Patent Application Publication
(10) Pub. No.: US 2026/0251587 A1
(43) Pub. Date: Aug. 27, 2026

(54) SYSTEMS AND METHODS FOR AUTOMATED COLLIMATION FIELDS ALIGNMENT

(71) Applicant: GE Precision Healthcare LLC, Waukesha, WI (US)

(72) Inventors: Romain Brevet, Buc (FR); Ruben Sanchez De La Rosa, Buc (FR)

(21) Appl. No.: 19/063,173

(22) Filed: Feb. 25, 2025

(51) Int. Cl. G01N 23/04

(52) U.S. Cl. CPC G01N 23/04; G01N 2223/1016; G01N 2223/306; G01N 2223/316; G01N 2223/401; G01N 2223/421; G01N 2223/6126

(57) ABSTRACT

Methods and systems for automated FOV alignment testing are herein provided. In one example, an x-ray system comprises an x-ray source, a detector, a collimator with a plurality of collimator blades, and a visible light, wherein the x-ray system is configured to acquire at least two images of one or more radiopaque objects positioned according to the visible light; detect, for each of the at least two images; the one or more radiopaque objects and the plurality of collimator blades; determine positions of an x-ray FOV and a light FOV based on the positions of the radiopaque objects and the blades; determine positions of a light FOV and an x-ray FOV for a clinical FOV; and determine a first FOV alignment for the clinical FOV between the light FOV and an x-ray FOV and a second alignment for the clinical FOV between the x-ray FOV and the detector.

### FIELD

Embodiments of the subject matter disclosed herein relate to medical imaging, and more particularly to automated collimation fields alignment testing.

### BACKGROUND

In medical imaging, for example mammography systems, an x-ray source and an x-ray detector are generally mounted on opposing ends of a substantially C-shaped gantry. In mammography, a light field of view (FOV) is used to position a breast of a patient. This light FOV is to be aligned properly with an x-ray FOV to ensure the imaging is performed at the correct position. Similarly, the x-ray FOV is also to be properly aligned with the detector active area. Both of these alignments (x-ray vs light and x-ray vs detector active area) are aimed to comply with predefined standards and with routine quality control testing.

Current methods to measure the location of the light FOV and the x-ray FOV for alignment testing/collimation purposes includes using expensive one-time radio-sensitive strips, alignment test objects, external x-ray detectors or x-ray cassettes and coins. All of these demand that the measurement devices be purchased and that a user position the devices on each individual existing FOV. Further, these methods require manual measurements and calculations to determine the alignment values.

### BRIEF DESCRIPTION

In one example, an x-ray system comprises an x-ray source, a detector, a collimator with a plurality of collimator blades, and a visible light, wherein the x-ray system is configured to acquire at least two images of one or more radiopaque objects positioned according to the visible light; detect, for each of the at least two images; the one or more radiopaque objects and the plurality of collimator blades; determine positions of an x-ray FOV and a light FOV based on the positions of the radiopaque objects and the blades; extrapolate positions of a light FOV and an x-ray FOV for a clinical FOV; and determine a first FOV alignment for the clinical FOV between the light FOV and an x-ray FOV and a second alignment for the clinical FOV between the x-ray FOV and the detector.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a pictorial view of an imaging system, according to an embodiment;

FIG. 2 shows a pictorial view of an exemplary imaging system, according to an embodiment;

FIG. 3 shows a flowchart illustrating a method for determining FOV positions;

FIG. 4 shows a flowchart illustrating a method for detecting radiopaque objects and collimator blades via line and circle detection;

FIG. 5 shows a flowchart illustrating a method for circle detection;

FIG. 6 shows a flowchart illustrating a method for line detection;

FIG. 7 shows a flowchart for FOV alignment testing;

FIG. 8 shows an example light FOV and radiopaque objections positioned therewithin;

FIG. 9 shows diagrams illustrating the method of FIG. 5; and

FIG. 10 shows diagrams illustrating the method of FIG. 6.

### DETAILED DESCRIPTION

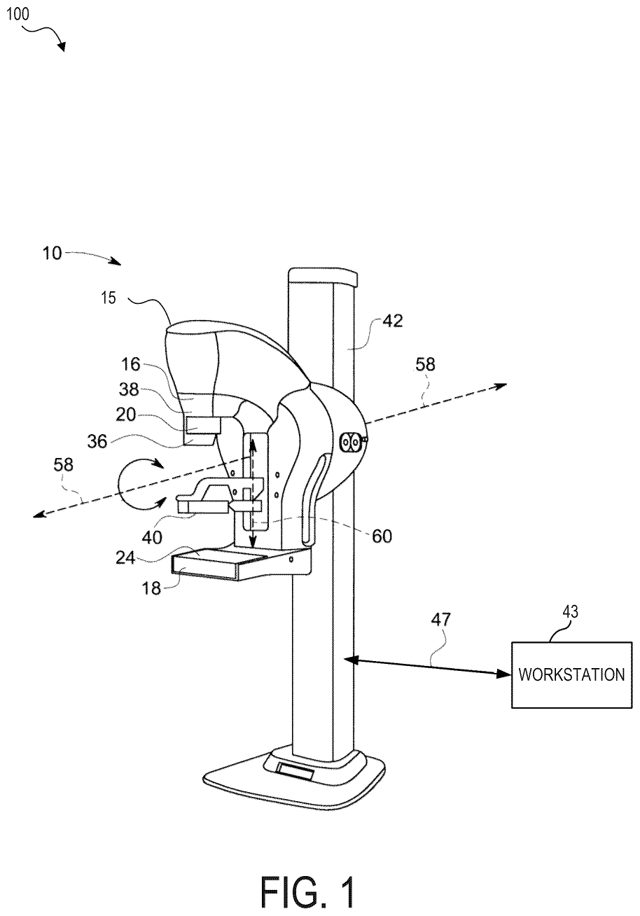

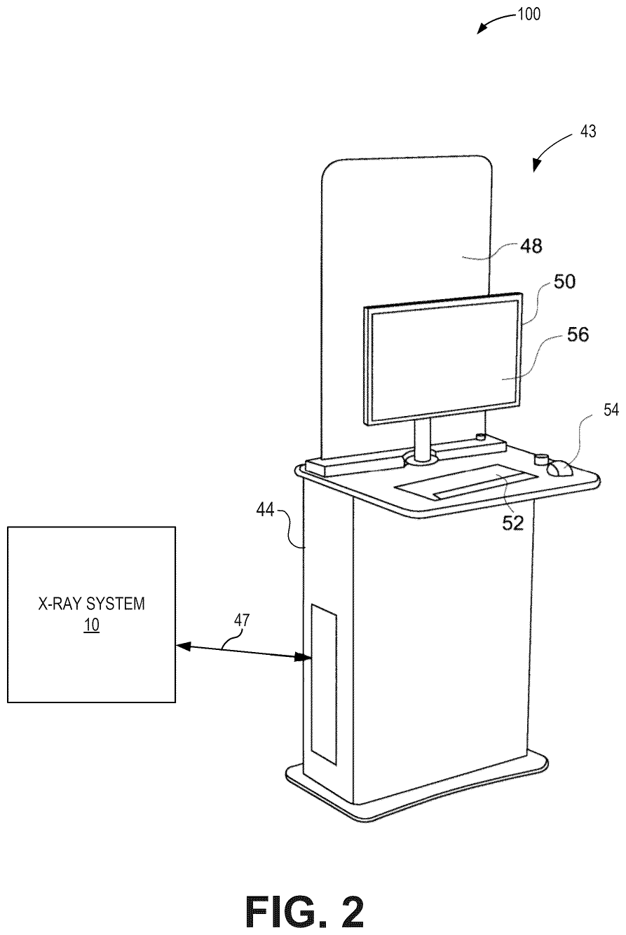

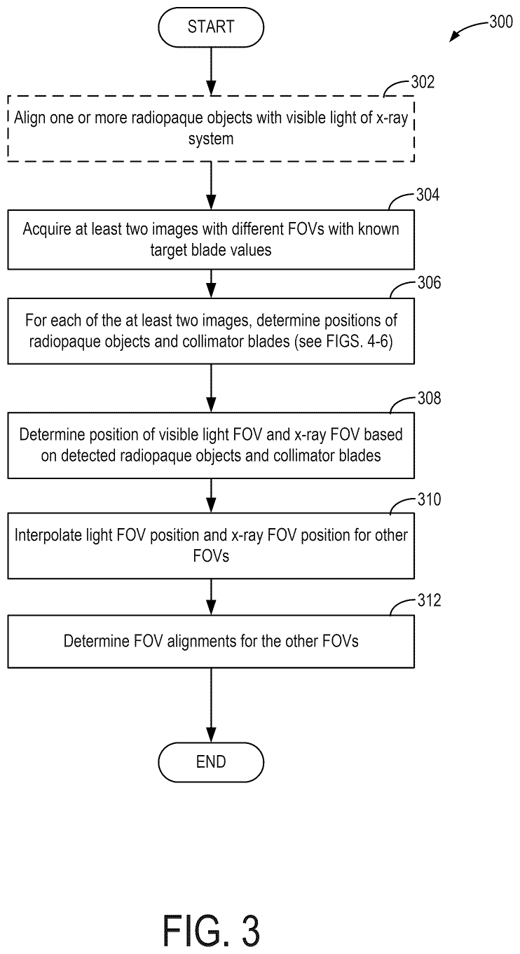

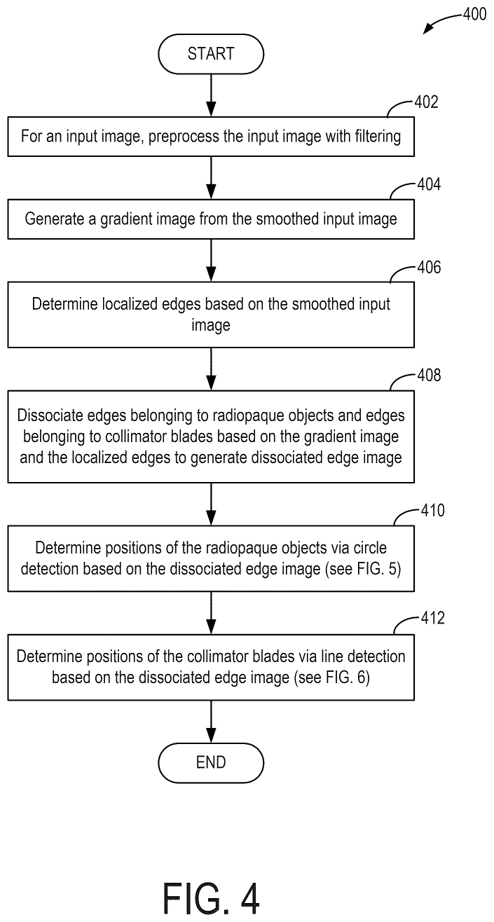

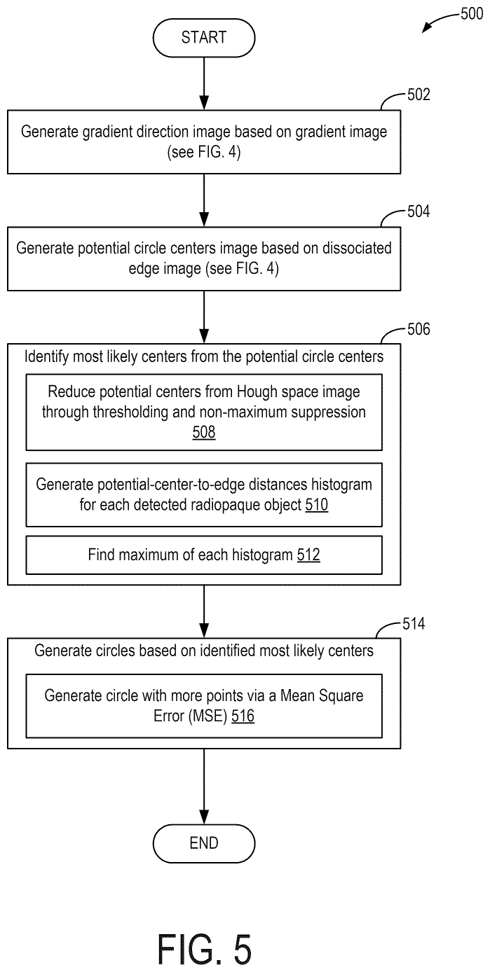

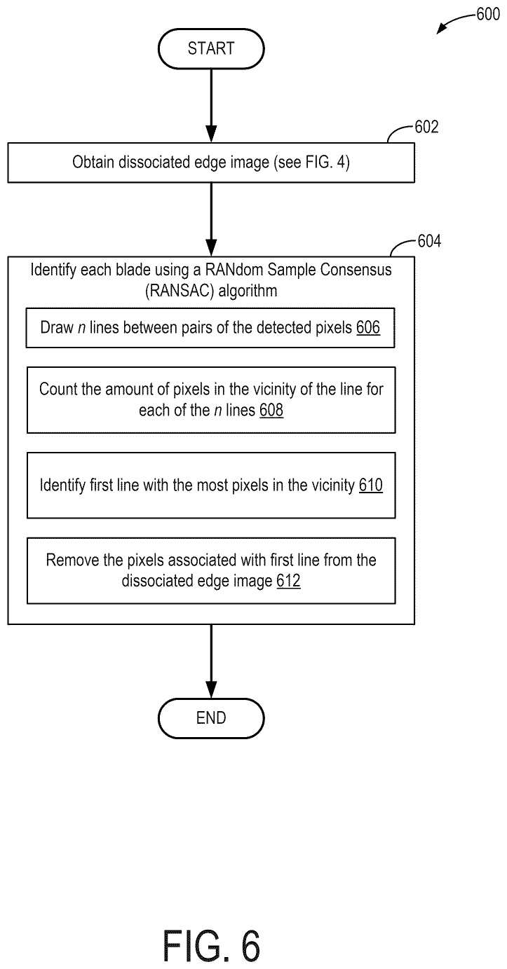

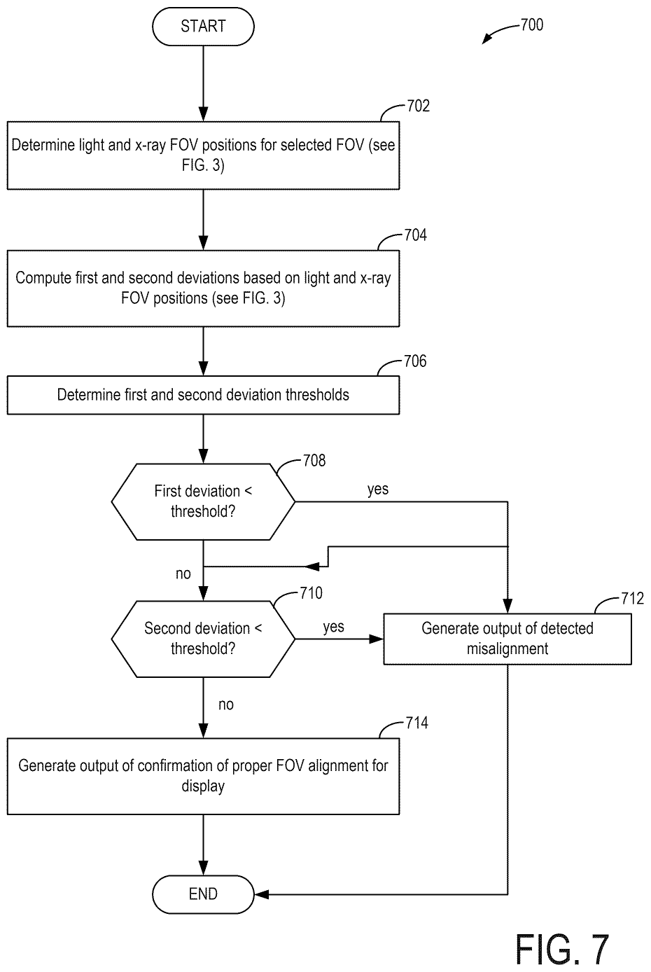

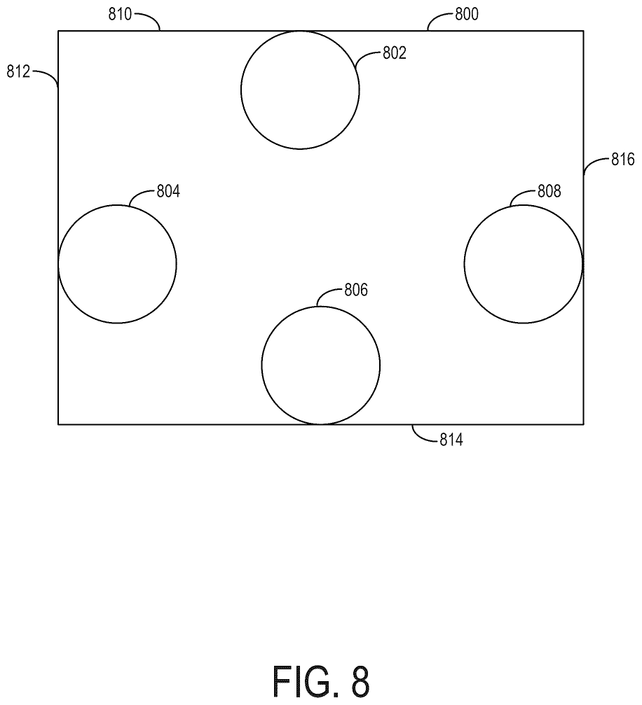

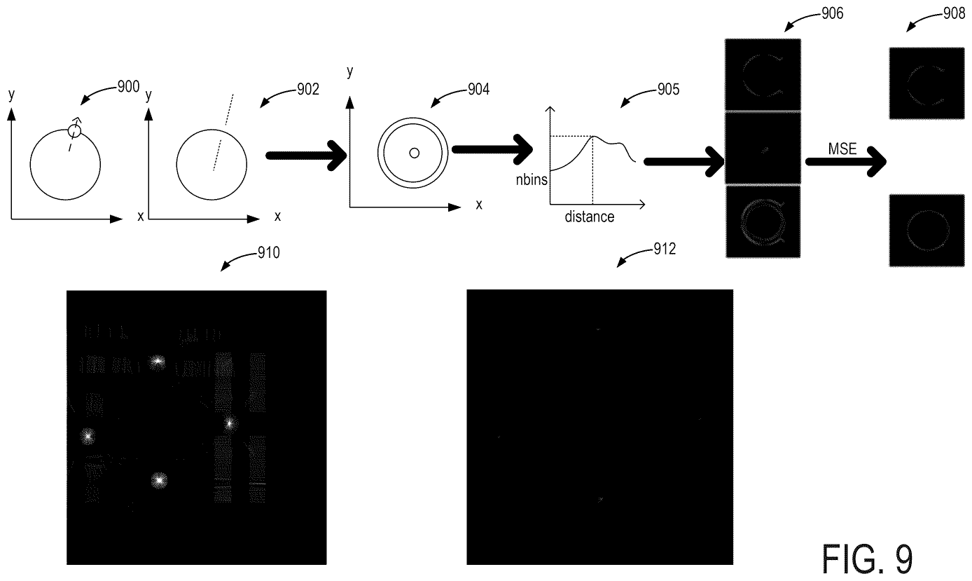

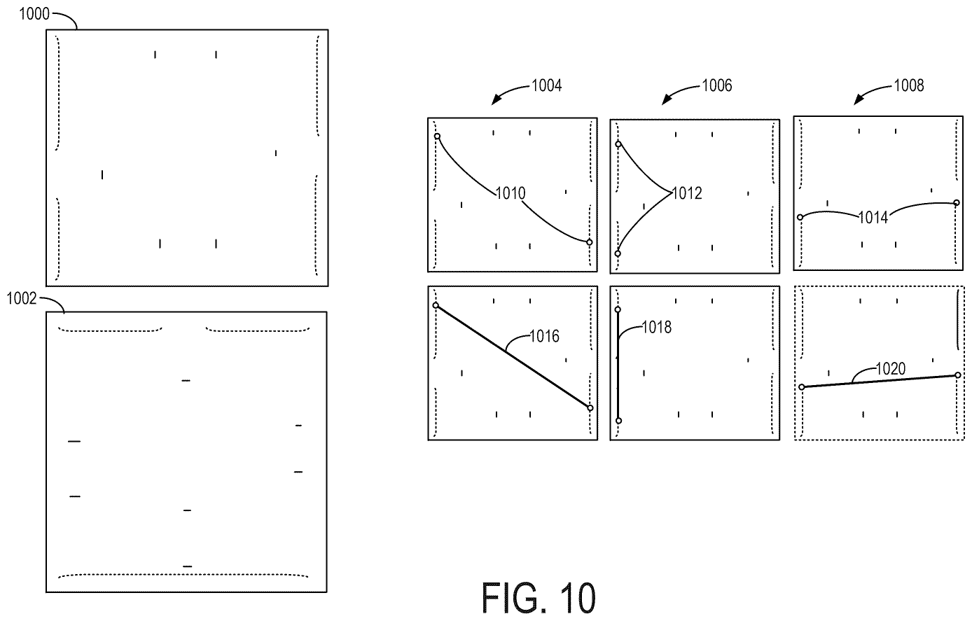

The following description relates to various embodiments of medical imaging. In particular, systems and methods automated collimation fields alignment testing for light and x-ray FOV positions of an x-ray system such as a mammography system. An example of an x-ray system is shown in FIGS. 1 and 2. The exemplary x-ray system as shown in FIGS. 1 and 2 is a mammography system, though it should be understood that other x-ray based systems may also apply without departing from the scope of this disclosure, such as computed tomography (CT) systems and the like. A method for determining light and x-ray FOV positions is shown in a flowchart in FIG. 3. The method of FIG. 3 includes detecting radiopaque objects and collimator blades in acquired images. A method for detecting radiopaque objects and collimator blades is described in a flowchart in FIG. 4. The method of FIG. 4 includes line detection and circle detection. A method for circle detection is described in a flowchart in FIG. 5 and shown diagrammatically in FIG. 9. A method for line detection is described in a flowchart in FIG. 6 and shown diagrammatically in FIG. 10. A method for alignment testing using the determined FOV positions is shown in FIG. 7. An example light FOV with radiopaque objects positioned therewithin is shown in FIG. 8.

Traditionally, testing FOV alignment for an x-ray system is a time-consuming process demanding specialized equipment. For example, current methods to measure the location of the light FOV and the x-ray FOV for alignment testing/collimation purposes includes using expensive one-time radio-sensitive strips, alignment test objects, or external x-ray detectors or x-ray cassettes. Such methods include determining FOV alignments for all available clinical FOVs that are required by defined standards for the system, which can be time-consuming for the user as well as burdensome from a processing efficiency perspective.

Systems and methods are presented herein for FOV alignment testing using easily accessible radiopaque objects like coins. For example, FOV alignment testing as herein disclosed includes acquiring at least two images with different, non-clinical FOVs. For example, a first non-clinical FOV may be an FOV that is smaller than the typical clinical FOVs of the system and a second non-clinical FOV may be an FOV that is larger than the typical clinical FOVs of the system. The radiopaque objects are aligned with a visible light of the system for each of the at least two non-clinical FOVs and images thereof are acquired. For each of the acquired images, the radiopaque objects and collimator blades of the system are detected, for example via circle detection and line detection. The positions thereof may then be used to estimate light FOV and x-ray FOV positions, which may be compared to known blade target values for the designated non-clinical FOVs. The comparison of positions and blade target values may allow for determination of estimated FOV positions for all clinical FOVs without having to individually determine FOV alignments therefor (e.g., take images for each clinical FOV). Deviation between FOVs can then be computed to determine alignment.

In this way, FOV alignment testing can be performed using easily accessible objects like coins, thereby mitigating the need for expensive, one-time use, specialized equipment. Further, by determining alignments for two non-clinical FOVs with a wide size range and extrapolating positions for all FOVs therebetween (e.g., clinical FOVs), the processing demands on the system may be reduced as less acquisitions and computations are needed to determine FOV alignments. Additionally, reducing the number of image acquisitions may reduce the length of time needed to perform the testing process.

Referring to FIG. 1, a digital mammography system 100 including an x-ray system 10 for performing a mammography procedure is shown, according to an embodiment of the present disclosure. The x-ray system 10 may be used to acquire one or more types of images during one or more acquisitions. It should be appreciated that the digital mammography system 100 described with respect to FIG. 1 is an example of an x-ray imaging system and other types of x-ray imaging systems may be used without departing from the scope of this disclosure.

The x-ray system 10 includes a support structure 42, to which a radiation source 16, a radiation detector 18, and a collimator 20 are attached. The radiation source 16 is housed within a gantry 15 that is movably coupled to the support structure 42. In particular, the gantry 15 may be mounted to the support structure 42 such that the gantry 15 including the radiation source 16 can rotate around an axis 58 in relation to the radiation detector 18. An angular range of rotation of the gantry 15 housing the radiation source 16 indicates a rotation up to a desired degree in either direction about the axis 58. For example, the angular range of rotation of the radiation source 16 may be −θ to +θ, where θ may be such that the angular range is a limited angle range less than 360 degrees. An exemplary x-ray system may have an angular range of ±11 degrees, which may allow rotation of the gantry (that is rotation of the radiation source) from −11 degrees to +11 degrees about an axis of rotation of the gantry 15. The angular range may vary depending on the manufacturing specifications. The angular range for digital mammography systems may be approximately ±11 degrees to ±60 degrees, depending on manufacturing specifications.

The radiation source 16 is directed towards a volume or object to be imaged and is configured to emit radiation rays at desired times to acquire one or more images. The radiation detector 18 is configured to receive the radiation rays via a surface 24. The detector 18 may comprise a photosensor pixel array that is optically coupled to a scintillator (e.g., of the surface 24). The scintillator may be disposed to receive incident radiation rays, such as x-rays. Optical photons generated in the scintillator in response to the incident radiation pass to the photosensor pixel array in which the light is detected and corresponding image data signals are generated by the photosensors in the array. The collimator 20 is disposed adjacent to the radiation source 16 and is configured to adjust an irradiated zone of a subject via one or more collimator blades (not shown). The collimator blades may be adjustable metal plates, such as made of tungsten or lead, that define the radiation exposure area via beam shaping, scatter reduction, and aperture adjustment. The collimator blades may be positioned at edges of the radiation source 16 and in a resultant x-ray image, the visible edges of the blades may indicate the boundary of the imaging field.

In some embodiments, the system 10 may further include a patient shield 36 mounted to the radiation source 16 via face shield rails 38 such that a patient's body part (e.g., head) is not directly under the radiation. The system 10 may further include a compression paddle 40, which may be movable upward and downward in relation to the support structure along a vertical axis 60. Thus, the compression paddle 40 may be adjusted to be positioned closer to the radiation detector 18 by moving the compression paddle 40 downward toward the detector 18, and a distance between the detector 18 and the compression paddle 40 may be increased by moving the compression paddle upward along the vertical axis 60 away from the detector. The movement of the compression paddle 40 may be adjusted by a user via a compression paddle actuator (not shown) included in the x-ray system 10. The compression paddle 40 may hold a body part, such as a breast, in place against the surface 24 of the radiation detector 18. The compression paddle 40 may compress the body part and hold the body part still in place while optionally providing apertures to allow for insertion of a biopsy needle, such as a core needle or a vacuum assisted core needle. In this way, compression paddle 40 may be utilized to compress the body part to minimize thickness traversed by the x-rays and to help reduce movement of the body part due to the patient moving. The x-ray system 10 may also include an object support (not shown) on which the body part may be positioned.

The digital mammography system 100 may further include a workstation 43, as further shown in FIG. 2. The workstation 43 may comprise a controller 44 including at least one processor and a memory (e.g., non-transitory memory). The memory may store instructions executable by the processor(s). The controller 44 may be communicatively coupled to one or more components of the x-ray system 10 including one or more of the radiation source 16, the radiation detector 18, the compression paddle 40, and a biopsy device. In some examples, the communication between the controller 44 and the x-ray system 10 may be via a wireless communication system. In other examples, the controller 44 may be in electrical communication with the one or more components of the x-ray system via a cable 47. Further, in an exemplary embodiment, as shown in FIG. 2, the controller 44 is integrated into the workstation 43. In other embodiments, the controller 44 may be integrated into one or more of the various components of the system 10 disclosed above. Further, the controller may include processing circuitry that executes stored program logic and may be any one of different computers, processors, controllers, or combinations thereof that are available for and compatible with the various types of equipment and devices used in the x-ray system 10.

The workstation 43 may include a radiation shield 48 that protects an operator of the system 10 from the radiation rays emitted by the radiation source 16. The workstation 43 may further include a display 50, a keyboard 52, mouse 54, and/or other appropriate user input devices that facilitate control of the system 10 via a user interface 56.

The controller 44 may adjust the operation and function of the x-ray system 10. As an example, the controller 44 may provide timing control, as to when the x-ray source 16 emits x-rays, and may further adjust how the detector 18 reads and conveys information or signals after the x-rays hit the detector 18, and how the x-ray source 16 and the detector 18 move relative to one another and relative to the body part being imaged. The controller 44 may also control how information, including images 42 and data acquired during the operation, is processed, displayed, stored, and manipulated, including FOV alignment testing. Various method steps as described herein with respect to FIGS. 3-7 may be performed by one or more processors of the controller 44 according to a set of instructions stored in non-transitory memory of the controller 44.

Further, as stated above, the radiation detector 18 receives the radiation rays emitted by the radiation source 16. In particular, during imaging with the x-ray system, a projection image of the imaging body part may be obtained at the detector 18. In some embodiments, data, such as projection image data, received by the radiation detector 18 may be electrically and/or wirelessly communicated to the controller 44 from the radiation detector 18. The controller 44 may then reconstruct one or more scan images based on the projection image data, by implementing a reconstruction algorithm, for example. The reconstructed image may be displayed to the user within user interface 56 via the display 50.

The radiation source 16, along with the radiation detector 18, forms part of the x-ray system 10 which provides x-ray imagery for the purpose of one or more of screening for abnormalities, diagnosis, dynamic imaging, image-guided biopsy, and/or system testing and calibration procedures. For example, the x-ray system 10 may be operated in a mammography mode for screening for abnormalities. During mammography, a patient's breast is positioned and compressed between the detector 18 and the compression paddle 40. Thus, a volume of the x-ray system 10 between the compression paddle 40 and the detector 18 is an imaging volume. The radiation source 16 then emits radiation rays on to the compressed breast, and a projection image of the breast is formed on the detector 18. The projection image may then be reconstructed by the controller 44, and displayed on the interface 50. During mammography, the gantry 15 may be adjusted at different angles to obtain images at different orientations, such as a cranio-caudal (CC) image and a medio-lateral oblique (MLO) image. In one example, the gantry 15 may be rotated about the axis 58 while the compression paddle 40 and the detector 18 remain stationary. In other examples, the gantry 15, the compression paddles 40, and the detector 18 may be rotated as a single unit about the axis 58.

Further, the x-ray system 10 may be operated in a tomosynthesis mode for performing digital breast tomosynthesis (DBT). During tomosynthesis, the x-ray system 10 may be operated to direct low-dose radiation towards the imaging volume (between the compression paddle 40 and the detector 18) at various angles over the angular range of the x-ray system 10. Specifically, during tomosynthesis, similar to mammography, the breast is compressed between the compression paddle 40 and the detector 18. The radiation source 16 is then rotated from −θ to +θ, and a plurality of projection images of the compressed breast is obtained at regular angular intervals over the angular range. For example, if the angular range of the x-ray system is ±11 degrees, 22 projection images may be captured by the detector during an angular sweep of the gantry at approximately one every one degree, generating a set of angulated x-ray images. The plurality of projection images are then processed by the controller 44 to generate a plurality of DBT image slices. The processing may include applying one or more reconstruction algorithms to reconstruct a three dimensional image of the breast. Furthermore, the x-ray system may be configured to perform a DBT-guided biopsy procedure. Accordingly, in some exemplary embodiments, the system 10 may further include a biopsy device comprising a biopsy needle for extracting a tissue sample for further analysis (e.g., pathology analysis).

In some examples, digital mammography system 100 may be configured to perform contrast imaging where contrast agents, such as iodine, can be injected into a patient and travel to the ROI within the breast (e.g., a lesion). The contrast agents are taken up in the blood vessels surrounding a cancerous lesion in the ROI, thereby providing a contrasting image for a period of time with respect to the surrounding tissue, enhancing the ability to locate the lesion.

In some embodiments, the digital mammography system 100 includes, or is coupled to, a picture archiving and communications system (PACS). In an exemplary implementation, the PACS is further coupled to a remote system such as a radiology departing information system, hospital information system, and/or to an internal or external network (not shown) to allow operators at different locations to supply commands and parameters and/or gain access to the image data.

In some examples, images reconstructed by the controller 44 may store the images reconstructed in a storage device. Alternatively, the images may be transmitted for generating useful patient information for diagnosis and evaluation. In certain embodiments, the controller 44 may transmit the reconstructed images and/or the patient information to the display 50. In some embodiments, the reconstructed images may be transmitted from the controller 44 to the storage device for store-term or long-term storage.

As is described herein, the body part of the patient (e.g., the breast) that is to be imaged via one or more of the imaging techniques herein described is aligned within the imaging system volume via a light FOV. In order for proper imaging of the positioned body part, the light FOV is to be aligned with the x-ray FOV. The x-ray FOV also is to be aligned with the detector 18 (e.g., an active area of the detector 18, like the surface 24). The various methods and processors (such as the methods described below with respect to FIGS. 3-7) described further herein may be stored as executable instructions in non-transitory memory on a computing device (or controller) in the imaging system (e.g., digital mammography system 100). In one embodiment, the controller 44 may include such executable instructions in non-transitory memory, and may apply the methods described herein for FOV alignment testing.

It should be understood that while a digital mammography system is herein described in FIGS. 1 and 2, other x-ray systems that use flat panel detectors, such as CT imaging systems, x-ray systems, fluoroscopy systems, interventional radiology systems, and the like, may also apply without departing from the scope of this disclosure.

Turning now to FIG. 3, a flowchart illustrating a method 300 for determining FOV positions is shown. The method 300 may be carried out using the systems and components described herein above with regards to FIGS. 1-2, however it should be understood that similar methods may be used with other systems without departing from the scope of this disclosure. The method 300 may be carried out via instructions stored in non-transitory memory of one or more computing devices of an x-ray system. For example, instructions may be stored in memory and executed by one or more processors of the controller 44 of x-ray system 10 of FIG. 1.

At 302, method 300 includes aligning one or more radiopaque objects with a visible light of the x-ray system. In one example, the one or more radiopaque objects may be coins. In other examples, the one or more radiopaque objects may be regularly shaped (e.g., circular, square, etc.) stones, or other readily-accessible objects that are radiopaque. The one or more radiopaque objects may be aligned with edges of the visible light via a manual process for at least two light FOVs. For example, the visible light may take a rectangular shape with four sides. The one or more radiopaque objects may comprise four objects, one being positioned at each of the four sides of the rectangular shaped visible light. As will be described below, the radiopaque objects may be aligned with the visible light of the system for a given FOV. For example, for a first FOV, the visible light may be a first size and the radiopaque objects may be aligned with the visible light for that first FOV. For a second, different FOV, the visible light may be a second, different size and the radiopaque objects may be aligned with the visible light for that second FOV. In some examples, this process may be repeated for additional FOVs if needed.

Turning briefly to FIG. 8, an example light FOV 800 is shown. A plurality of radiopaque objects may be positioned at edges of the light FOV 800. In the example shown, the radiopaque objects are of circular shape, such as when coins are used as radiopaque objects. For example, a first radiopaque object 802 may be placed at or near a top edge 810 of the light FOV 800, a second radiopaque object 804 may be placed at or near a first side edge 812 of the light FOV 800, a third radiopaque object 806 may be placed at or near a bottom edge 814 of the light FOV 800, and a fourth radiopaque object 808 may be placed at or near a second side edge 816 of the light FOV 800. “At or near” in this context may describe positioning the corresponding radiopaque object such that at least a point of the edge of the radiopaque object contacts the corresponding edge of the light FOV with a center of the radiopaque object being positioned within the light FOV. For example, the radiopaque object may be positioned such that an edge point of the radiopaque object is at the edge of the light FOV. This may allow for determination of the position of the light FOV by detection of the center and radius of each of the radiopaque objects, as will be herein described.

Returning to FIG. 3, at 304, method 300 includes acquiring at least two images with the x-ray system with known target blade values with the one or more radiopaque objects as positioned. As described above, the x-ray system may include a collimator with collimator blades. The collimator blades may have known target positions/values. With the radiopaque objects positioned at edges of the visible light of the system, the acquired at least two images may include imaging data of the radiopaque objects. At least portions of the collimator blades of the system (e.g., the edges of the collimator blades) may also be included in the at least two images.

The at least two images (e.g., first and second images) may have been acquired with non-clinical FOVs. In some examples, a first image of the at least two images may have a first relatively small FOV with first known target blade values and a second image of the at least two images may have a second relatively large FOV (as compared to the first image) with second known target blade values. In order to acquire the at least two images, the radiopaque objects may be aligned with the light FOV for the first FOV and the first image may be acquired thereof and, separately, the radiopaque objects may be aligned with the light FOV for the second FOV and the second image may be acquired thereof. In this way, the first image may include data of the radiopaque objects when aligned for the first FOV and the second image may include data of the radiopaque objects when aligned for the second FOV.

At 306, method 300 includes, for each of the at least two images (e.g., the first and second images), determining the positions of the radiopaque objects and the collimator blades. As will be further described with respect to FIGS. 4-6, the radiopaque objects and the collimator blades may be detected by localizing edges, dissociating edges that belong to the radiopaque objects and those that belong to the blade, and performing line and circle detection. Line and circle detection, as will be herein described, may allow for detection of the position of each of the imaged radiopaque objects and each of the plurality of collimator blades.

At 308, method 300 includes determining a position of the visible light FOV and a position of the x-ray FOV based on the positions of the detected radiopaque objects and collimator blades. For example, detection of the radiopaque objects may inform the position of the visible light and detection of the collimator blades may inform the position of the x-ray beam. Determining the positions of the light and x-ray beam in this way may reduce the number of FOVs that have to be measured, thereby reducing overall system processing demands and the time of the alignment procedure.

As an example, the estimated positions of the light FOV as determined based on the position of the detected coins may be compared with the known target blade values for all of the at least two images. For example, for each known target blade position, the corresponding estimated light FOV position may be associated to the target blade position. This association may result in a data point. This process may be repeated for each FOV acquired, generating multiple data points. These data points may then be interpolated to obtain a generalized relationship between the known target blade position and the light FOV position. This may be performed for each target blade position within the FOV. In a similar fashion, the positions of the x-ray FOV as determined based on the position of the detected collimator blades may be compared with the known target blade values for all of the at least two images.

At 310, method 300 includes interpolation of light FOV position and the x-ray FOV position for other FOVs. As described above, the at least two images may be acquired for a first FOV that is relatively small and a second FOV that is relatively large. These may be non-clinical FOVs, in some examples. Based on the comparison between the known target blade values and the estimated FOV positions, as described above, the positions of the light FOV and x-ray FOV may be determined for other FOVs with sizes between the first and second FOVs. For example, the first non-clinical FOV may be smaller than the second non-clinical FOV and the clinical FOV may be larger than the first non-clinical FOV and smaller than the second non-clinical FOV. These other FOVs may be clinical FOVs that also have known blade values. Thus, with the known blade values of the clinical FOVs and the estimated interpolation of FOV positions vs target blade values, the positions of the light FOV and x-ray FOV for the clinical FOVs may be determined. The clinical FOVs that are chosen may be the clinical FOVs that are in use for a particular chosen procedure, for example the user who may be running the alignment testing may indicate which FOVs are to be considered. In other examples, FOV positions for all available clinical FOVs may be extrapolated based on the determined FOV positions of the non-clinical FOVs.

At 312, method 300 includes determining FOV alignment for the other FOVs. As described above, the relationship between each known target blade value and their corresponding light FOV position and each known target blade value and their corresponding x-ray FOV position may be determined. Through these relationships, the light FOV positions and x-ray FOV positions for any other clinical or non-clinical target blade positions may be computed. The difference between the computed light FOV and x-ray FOV positions and the difference between the computed x-ray FOV positions and the known detector active area position can be compared to the maximum regulated values. The FOV alignment may be generated as the values of the differences for each of a first FOV alignment (light FOV vs x-ray FOV) and a second FOV alignment (x-ray FOV vs detector active area). As will be described further with respect to FIG. 7, the alignment values may be used to determine if the collimation of the system is within a predefined threshold of typical values for a given standard (e.g., an international standard, a local or regional standard, a quality control testing standard, etc.).

In this way, alignments between the light FOV, the x-ray FOV, and the detector active area may be determined using images acquired for as little as two non-clinical FOVs. By acquiring the two non-clinical FOVs that span FOV sizes, the positions of the light FOV and x-ray FOV may be extrapolated for other clinical FOVs, which may overall reduce processing demands for the x-ray system by reducing the number of image acquisitions needed to perform alignment testing and reducing the number of FOV alignment determinations (including how many times radiopaque objects or other markers are detected via image processing).

Determining alignments as such may allow for more accurate image acquisitions. For example, determining the alignment between the light FOV and the x-ray FOV may allow for detection of misalignment of the light FOV, therefore mitigating malpositioning of a body part that is positioned using the light FOV. Similarly, determining the alignment between the x-ray FOV and the detector active area may allow for detection of misalignment of the x-ray FOV, therefore mitigating image acquisition using a misaligned x-ray source. Further, using coins as radiopaque objects may decrease usage of one-time use radio-sensitive strips or other alignment test objects.

Turning now to FIG. 4, a flowchart illustrating a method 400 for detecting the radiopaque objects and collimator blades is shown. The method 400 may be carried out using the systems and components described herein above with regards to FIGS. 1-2, however it should be understood that similar methods may be used with other systems without departing from the scope of this disclosure. The method 400 may be carried out via instructions stored in non-transitory memory of one or more computing devices of an x-ray system. For example, instructions may be stored in memory and executed by one or more processors of the controller 44 of x-ray system 10 of FIG. 1. The method 400 may be incorporated as part of a method for FOV alignment, such as at 306 of the method 300 discussed above. It should be understood that while the method 400 is herein described as may be applied to one of the at least two input images, it may be applied separately to each of the acquired images.

At 402, method 400 includes for an input image, preprocessing the input image with filtering. In some examples, preprocessing the input image may comprise smoothing the image. The input image may be one of the at least two acquired images described above. Filtering may comprise applying a median filter, in some examples. The median filter may include applying a kernel over windows of the image to determine median intensity values within the window and then applying that value to the center pixel of the window. This process is repeated for every pixel in the image, producing a smoothed output.

At 404, method 400 includes generating a gradient image based on the smoothed input image. The gradient image may be generated by using a Sobel filter. The Sobel filter may include calculating the gradient of the intensity at each pixel of the smoothed input image, emphasizing changes in intensity such as those that occur at edges. The Sobel filter may comprise using two kernels, one for detecting changes in the horizontal direction and one for detecting changes in the vertical direction of the smoothed input image. The smoothed input image is then convolved with each kernel, generating the gradient image.

At 406, method 400 includes determining localized edges based on the smoothed input image and the gradient image. The localized edges may be determined via a Canny edge detection algorithm. The Canny edge detection algorithm may comprise identifying and retaining pixels that are local maxima in each gradient direction of the gradient image. Strong edges, determined as pixels with gradient magnitudes over a first threshold, are then distinguished from weak edges, determined as pixels with gradient magnitudes between the first threshold and a lower, second threshold, and non-edges, determined as pixels with gradient magnitudes below the lower, second threshold. All non-edges are discarded and weak edges that are not connected to strong edges are also discarded. Thus, strong edges and connected weak edges may be identified for edge detection.

At 408, method 400 includes dissociating edges belonging to the one or more radiopaque objects and edges belonging to collimator blades based on the gradient image and the localized edges to generate a dissociated edge image. The radiopaque object edges may be dissociated from the blade edges in various manners. For example, gradient clustering may be applied to the Canny edge algorithm output, which may be a binary map in some examples. For example, gradient information can be used to group edges into clusters that likely belong to the same object and type of object. In another example, the edge data may be combined with other information that is distinct between the radiopaque objects and the blades like pixel intensity or the shape to group edges corresponding to either the radiopaque objects (e.g., coins) and the blades. In some examples, a first dissociated edge image corresponding to the radiopaque objects may be generated and a second dissociated edge image corresponding to the collimator blades. In other examples, the dissociated edge image may comprise data of both edges.

At 410, method 400 includes determining positions of the radiopaque objects via circle detection based on the dissociated edge image. As will be further described with respect to the method 500 of FIG. 5 (and FIG. 9), circle detection may comprise defining potential circle centers and radii and then the most likely circle center for each of the identified radiopaque objects.

At 412, method 400 includes determining positions of the collimator blades via line detection based on the dissociated edge image. As will be further described with respect to the method 600 of FIG. 6 (and FIG. 10), line detection may comprise using a RANdom SAmple Consensus (RANSAC) algorithm to identify lines with the most pixels in respective vicinities to identify each of the identified collimator blades, though it should be understood that other line detection algorithms may be used in other examples.

In this way, the methods herein may detect both the radiopaque objects and the collimator blades and determine their positions. This may allow for determining the relative positions of the radiopaque objects and the collimator blades with respect to the target blade values for the given non-clinical FOVs. In doing so, FOV alignment may be determined for the non-clinical FOVs, and for clinical FOVs via extrapolation, as discussed above.

Turning now to FIG. 5, a flowchart illustrating a method 500 of circle detection is shown. The method 500 may be carried out using the systems and components descried herein above with regards to FIGS. 1-2, however it should be understood that similar methods may be used with other systems without departing from the scope of this disclosure. The method 500 may be carried out via instructions stored in non-transitory memory of one or more computing devices of an x-ray system. For example, instructions may be stored in memory and executed by one or more processors of the controller 44 of x-ray system 10 of FIG. 1. The method 500 may be incorporated as part of a method for detection of radiopaque objects and collimator blades, such as at 410 of the method 400 discussed above.

At 502, method 500 includes generating a gradient direction image based on the gradient image. As described with respect to method 400 of FIG. 4, a gradient image is generated from the smoothed input image. The gradient image comprises gradients in both the horizontal and vertical direction, allowing for generation of a gradient direction image.

At 504, method 500 includes generating a potential circle centers image based on the dissociated edge image and the gradient direction image. The potential circle centers image may be obtained using a Hough transform. As is described with respect to FIG. 4, a Canny edge detection algorithm may be applied to a smoothed inputted image/gradient image to generate a binary map of detected edges. Then, the detected edges may be separated into blade edges and radiopaque object edges in a dissociated edge image. When the radiopaque objects are coins they may thus be shaped as circles. In Hough space, the potential circle centers may be determined. As an example, for a given point (e.g., pixel) of the edge of a given detected radiopaque object, the potential circle centers may be determined along the gradient direction of that given point.

At 506, method 500 includes identifying the most likely centers from the potential circle centers. Identifying the most likely centers may comprise reducing the potential centers from the Hough space image through thresholding and non-maximum suppression, as noted at 508, generating a potential-center-to-edge distances histogram for each detected radiopaque object, as noted at 510, and finding the maximum of each histogram, as noted at 512. The maximum of each histogram may represent the point that is the most likely radius of the corresponding radiopaque object.

Turning briefly to FIG. 9, a diagram demonstrating the method 500 for circle detection is shown. An exemplary gradient direction image 900 is shown, with a point of the detected radiopaque object and a corresponding gradient direction of that point (e.g., pixel) demonstrated. The gradient direction image 900 is shown in image space. The gradient direction image 900 may be fed into the Hough transform to generate a Hough space image 902. As described above, applying the Hough transform may a plurality of potential centers in the gradient direction for a corresponding pixel of the corresponding edge. The Hough space image 902 may exist in Hough space, demonstrated by map 910.

Accumulation thresholding and non-maxima suppression may then be applied to the Hough space image 902 (e.g., as at 508) to reduce the number of potential centers, as shown in graph 904. Accumulation thresholding and non-maxima suppression, for example, may comprise filtering out potential centers that reside within a threshold distance of the detected edge. Each remaining potential center may then be plotted in potential-center-to-edge distances histogram 905. The potential-center-to-edge distances histogram may plot the distance between the given edge point and each of the potential centers. The maximum distance plotted in this potential-center-to-edge distances histogram 905 may thus be identified as the most likely radius, as the radius of a circle is by definition the longest distance between an edge and a potential center.

Returning to FIG. 5, at 514, method 500 includes generating a circle for each of the detected radiopaque objects based on the identified most likely centers. The circle may be defined by clustering and preserving edge points included in the clusters. Optionally, a weighted Mean Square Error (MSE) may be applied along with the Hough transform, as noted at 516. For example, to improve the precision given by the Hough transform that returns a circle based on the maximum approach described above, the weighted MSE may be used to return a circle that takes more points into account.

Returning to FIG. 9, generated circles 906 are shown resulting from the histogram maximum determination, as herein described. Applying the weighted MSE as described above may generate smoothed circles 908. Further, a centers matrix map 912 is shown, wherein each detected radiopaque object is defined by a number of defined radii (e.g., maximum distances between most likely centers and edges). The centers matrix map 912 may be generated following the Hough transform and histogram maximum determination as described above may include a plurality of circles defined by the determined radii.

In this way, as is described with respect to FIG. 5 and FIG. 9, the center point of each of the detected radiopaque objects may be determined based on circle detection. The center point and the determined radii (e.g., the largest distance between a potential center and the circle edge) may then be used to define the position of the corresponding radiopaque object with respect to the inputted image (e.g., one of the two acquired images).

Turning now to FIG. 6, a flowchart illustrating a method 600 for line detection is shown. The method 600 may be carried out using the systems and components descried herein above with regards to FIGS. 1-2, however it should be understood that similar methods may be used with other systems without departing from the scope of this disclosure. The method 600 may be carried out via instructions stored in non-transitory memory of one or more computing devices of an x-ray system. For example, instructions may be stored in memory and executed by one or more processors of the controller 44 of x-ray system 10 of FIG. 1. The method 600 may be incorporated as part of a method for detection of radiopaque objects and collimator blades, such as at 412 of the method 400 discussed above.

At 602, method 600 includes obtaining the dissociated edge image. As described with respect to FIG. 4, a Canny edge detection algorithm may be applied to a smoothed inputted image/gradient image to generate a binary map of detected edges. Then, the detected edges may be separated into blade edges and radiopaque object edges in a dissociated edge image. The dissociated edge image may thus comprise a plurality of detected pixels that correspond to detected collimator blades.

At 604, method 600 includes identifying each blade using a RANSAC algorithm. Identifying each blade using the RANSAC algorithm may comprise drawing n lines between pairs of the detected pixels, as noted at 606. The pairs of the detected pixels may be different random pairs of pixels for each of the n iterations. Then, for each of the n lines, the amount of pixels in the vicinity of the line may be counted, as noted at 608. For example, a drawn line may pass through or pass near to (e.g., within a threshold distance of) one or more of the detected pixels. The number of detected pixels that are passed through or passed nearby by the drawn line may be counted.

A blade may be identified by taking the line that includes the most pixels in its vicinity, as noted at 610. The pixels that are identified for the blade may then be remoted from the dissociated edge image, as noted at 612, and the process may be repeated for the next blade (e.g., drawing lines, counting pixels, and identifying the line that includes the most pixels in the vicinity).

FIG. 10 shows an example of line detection for detection of collimation blades in accordance with the method 600 of FIG. 6. Image 1000 shows vertical edge points of a dissociated edge image and image 1002 shows horizontal edge points of the dissociated edge image. In the example shown, the dissociated edge image comprises edge points of both the collimator blades and the radiopaque objects.

As described above, during line detection, a plurality of lines may be drawn between two random points of the dissociated edge image. In a first iteration 1004, a first pair of points 1010 is defined, in a second iteration 1006, a second pair of points 1012 is defined, and in a third iteration 1008, a third pair of points 1014 is defined. In the first iteration 1004, a first line 1016 is drawn between the first pair of points 1010. In the second iteration 1006, a second line 1018 is drawn between the second pair of points 1012. In the third iteration 1008, a third line 1020 is drawn between the third pair of points 1014.

The number of points along each of the first, second, and third lines 1016, 1018, and 1020 may be counted. As an example, in the example shown in FIG. 10, the first line 1016 may have two detected pixels in its vicinity—the first pair of points 1010, as the first line 1016 does not pass through or near any other detected edge pixels. Similarly, the third line 1020 may have the third pair of points 1014 in its vicinity, without significantly more as it does not pass through or near pixels corresponding to a collimator blade edge. The second line 1018 however, passes through a larger number of detected pixels and thus has more pixels within its vicinity that are counted. The pixels within the vicinity of the second line 1018 may thus be considered the edge of one of the collimator blades and may be removed from the iteration for detection of the next collimator blade (thereby mitigating “finding” the same collimator blade more than once).

Turning now to FIG. 7, a flowchart illustrating a method 700 for FOV alignment testing based on determined FOV positions is shown. The method 700 may be carried out using the systems and components descried herein above with regards to FIGS. 1-2, however it should be understood that similar methods may be used with other systems without departing from the scope of this disclosure. The method 700 may be carried out via instructions stored in non-transitory memory of one or more computing devices of an x-ray system. For example, instructions may be stored in memory and executed by one or more processors of the controller 44 of x-ray system 10 of FIG. 1.

At 702, method 700 includes determining light and x-ray FOV positions for a selected FOV. The selected FOV may be a clinical FOV, and the light and x-ray FOV positions for that selected FOV may be determined based on identifying the positions of one or more radiopaque objects and collimator blades for at least two non-clinical FOVs, as described with respect to FIGS. 3-6. As described above, light and x-ray FOVs may be determined based on a relationship between each known target blade value and their corresponding estimated light FOV position and each known target blade value and their corresponding estimated x-ray FOV position. These relationships can then be used to determine light and x-ray FOV positions for the selected FOV.

At 704, method 700 includes computing first and second deviations for the first and second FOV alignments, respectively. The first deviation may describe how different the positions of the light FOV and the x-ray FOV are (e.g., a first FOV alignment). The second deviation may describe how different the positions of the x-ray FOV and the detector active area are (e.g., a second FOV alignment). The difference between the computed light FOV and x-ray FOV positions may define the first deviation. The difference between the computed x-ray FOV positions and the known detector active area position may define the second deviation.

At 706, method 700 includes determining first and second deviation thresholds. As described above, the difference between the computed light FOV and x-ray FOV positions and the difference between the computed x-ray FOV positions and the known detector active area positions may be considered in relation to a given standard. For example, international standards, local or regional standards, and quality control testing standards may be available. A user may select which standard is to be considered for the testing protocol prior to alignments are computed or following computation of alignments. For example, the user may select a standard from a list of available standards via a user interface of the x-ray system. The first threshold may define a margin of error for the light FOV with respect to the x-ray FOV that is acceptable for the x-ray system according to the selected standard. The second threshold may define a margin of error for the x-ray FOV with respect to the detector active area that is acceptable for the x-ray system for the selected standard. In this way, the alignment testing and comparison may dynamically adapt to a desired standard for testing.

At 708, method 700 includes determining whether the first deviation is greater than the first threshold. If the first deviation is greater than the first threshold, the light FOV and x-ray FOV may be considered misaligned. If the first deviation is greater than the first threshold, method 700 proceeds to 712 to generate an output of the detected misalignment. For example, an alert may be displayed on a display device of the x-ray system (e.g., within user interface 56 of display 50) indicating to the user that misalignment between the light FOV and the x-ray FOV has been detected during testing.

At 710, method 700 includes determining whether the second deviation is greater than a second threshold. Determination of whether the second deviation is greater than the second threshold may occur whether or not the first deviation is greater than the first threshold. Thus, both determinations may be performed irrespective of the other's result. When the second deviation is greater than the second threshold, method 700 proceeds to 712 to generate an output of detected misalignment, which as described above may be outputted to the display device of the x-ray system. When both the first deviation is greater than the first threshold and the second deviation is greater than the second threshold, the generated output may comprise information of both misalignments. When only one of the two deviations indicates misalignment, the generated output may comprise information of only that misalignment.

In some examples, the generated output indicating the detected misalignment(s) may comprise just an indication that a misalignment is detected. In other examples, the generated output indicating the detected misalignment(s) may comprise indications of what the misalignments are as well as how much misalignment there is (e.g., how much deviation there is), thus informing the user by how much the FOVs are to be realigned for proper alignment. In other examples, the methods for FOV alignment testing herein described may be coupled with an alignment method that uses the testing results to actuate movements in the components of the system to align the FOVs. Thus, the method for alignment may not have to calculate deviations themselves, rather just use the calculated deviations from the methods herein described for alignment.

When the first deviation is less than the first threshold and the second deviation is less than the second threshold, method 700 proceeds to 714 to generate an output of confirmation of proper FOV alignment for display on the x-ray system display device. For example, the FOV alignment testing protocol herein described may be run by the x-ray system computing system and when proper alignment is confirmed as herein described, a notification of proper alignment may be displayed to the user via the display device of the x-ray system.

The technical effect of the methods and systems herein discussed is that FOV alignment testing may be performed in a more time-efficient and processing-efficient manner. The methods herein reduce the number of image acquisitions needed to perform alignment testing, which both increases processing efficiency as well as time efficiency. Further, radiopaque objects like coins may be an easily accessible and low-expenditure manner of determining light FOV positions, thereby mitigating the need for expensive specialized equipment.

The disclosure also provides support for an x-ray system, comprising: an x-ray source configured to emit an x-ray beam, a detector configured to detect the x-ray beam, a visible light, a collimator comprising a plurality of collimator blades, and a controller comprising one or more processors and memory storing instructions that when executed cause the one or more processors to: acquire at least two images of one or more radiopaque objects positioned according to the visible light, wherein a first image is acquired according to a first x-ray field of view (FOV) with a first target blade value and a second image is acquired according to a second x-ray FOV with a second target blade value, determine, for each of the at least two images, positions of the one or more radiopaque objects and the plurality of collimator blades, determine positions of x-ray FOVs and light FOVs with respect to the first target blade value and the second target blade value based on the positions of the plurality of collimator blades and the one or more radiopaque objects, determine positions of a third light FOV and a third x-ray FOV for a clinical FOV with a third target blade value based on the positions of the x-ray FOVs and light FOVs with respect to the first and second target blade values, determine a first FOV alignment for the clinical FOV between the third light FOV and the third x-ray FOV and a second alignment for the clinical FOV between the third x-ray FOV and the detector, and output the first and second alignment. In a first example of the system to detect the one or more radiopaque objects and the plurality of collimator blades, the controller is configured to, for each of the first and second images: preprocess the image, generate a gradient image from the preprocessed image, determine localized edges based on the gradient image and the preprocessed image, and generate a dissociated edge image based on the localized edges, wherein the dissociated edge image comprises dissociated edges belonging to the one or more radiopaque objects and edges belonging to the plurality of collimator blades. In a second example of the system, optionally including the first example to determine the positions of the one or more radiopaque objects, the controller is configured to, for each of the at least two images, perform circle detection and, to determine the positions of the one or more collimator blades, the controller is configured to, for each of the at least two images, perform line detection. In a third example of the system, optionally including one or both of the first and second examples to perform circle detection, the controller is configured to: generate a gradient direction image based on the gradient image, determine one or more potential circle centers based on the dissociated edge image and the gradient direction image, and identify a most likely center and radius for each of the one or more radiopaque objects. In a fourth example of the system, optionally including one or more or each of the first through third examples, identifying the most likely center comprises applying accumulation thresholding and non-maxima suppression. In a fifth example of the system, optionally including one or more or each of the first through fourth examples to perform line detection, the controller is configured to apply a RANdom Sample Consensus (RANSAC) algorithm. In a sixth example of the system, optionally including one or more or each of the first through fifth examples to determine the first FOV alignment (light versus x-ray), the controller is configured to: determine a difference between the third light FOV position and the third x-ray FOV position of a determined FOV corresponding to the clinical FOV. In a seventh example of the system, optionally including one or more or each of the first through sixth examples to determine the second alignment (x-ray versus detector), the controller is configured to determine a difference between the third x-ray FOV position and a position of a detector active area of a determined FOV corresponding to the clinical FOV. In a eighth example of the system, optionally including one or more or each of the first through seventh examples, the x-ray system is a mammography system. In a ninth example of the system, optionally including one or more or each of the first through eighth examples, the one or more radiopaque objects are coins.

The disclosure also provides support for a method for an x-ray system comprising an x-ray source, a detector, and a collimator with a plurality of collimator blades, comprising: acquiring a first image and a second image of one or more radiopaque objects with the x-ray system for a first non-clinical field of view (FOV) and a second non-clinical FOV, respectively, wherein the first and second non-clinical FOVs have known target blade values, determining, for each of the first and second images, positions of the one or more radiopaque objects and positions of the plurality of collimator blades, determining, based on the positions of the one or more radiopaque objects and the positions of the plurality of collimator blades, a position of a light FOV and a position of an x-ray FOV for each of the first non-clinical FOV and the second non-clinical FOV, determining a first relationship between the determined position of the light FOV and corresponding known target blade values of the first and second non-clinical FOV and a second relationship between the determined position of the x-ray FOV and the known target blade values of the first and second non-clinical FOV, determining, based on the comparison, light FOV positions and x-ray FOV positions for one or more clinical FOVs, and computing, based on the light FOV positions and the x-ray FOV positions, a first FOV alignment between the light FOV and the x-ray FOV and a second FOV alignment between the x-ray FOV and an active area of the detector. In a first example of the method, the one or more radiopaque objects are coins. In a second example of the method, optionally including the first example, determining the positions of the one or more radiopaque objects and the plurality of collimator blades comprises, for each of the first and second images: smoothing the image, generating a gradient image from the smoothed image, determining localized edges based on the gradient image and the smoothed image, and generating a dissociated edge image based on the localized edges, wherein the dissociated edge image comprises dissociated edges belonging to the one or more radiopaque objects and edges belonging to the plurality of collimator blades. In a third example of the method, optionally including one or both of the first and second examples, determining the positions of the one or more radiopaque objects further comprises: generating a gradient direction image based on the gradient image, determining one or more potential circle centers based on the dissociated edge image and the gradient direction image, and identifying a most likely center for each of the one or more radiopaque objects. In a fourth example of the method, optionally including one or more or each of the first through third examples, determining the positions of the plurality of collimator blades further comprises, for a first collimator blade: drawing a plurality of lines between pairs of pixels of the dissociated edge image, and identifying a line of the plurality of lines with the most pixels in a vicinity of the line. In a fifth example of the method, optionally including one or more or each of the first through fourth examples, computing the first FOV alignment comprises computing a difference between the light FOV position and the x-ray FOV position for the one or more clinical FOVs and wherein computing the second FOV alignment comprises computing a difference between the x-ray FOV position and a position of the active area of the detector for the one or more clinical FOVs. In a sixth example of the method, optionally including one or more or each of the first through fifth examples, the x-ray system is a mammography system.

The disclosure also provides support for a mammography system, comprising: an x-ray source configured to emit an x-ray beam, a detector configured to detect the x-ray beam, a visible light, a collimator comprising a plurality of collimator blades, and a controller comprising one or more processors and memory storing instructions that when executed cause the one or more processors to: acquire a first image of one or more coins corresponding to a first non-clinical field of view (FOV), wherein the first non-clinical FOV has a first known target blade value, wherein for the first image the one or more coins are aligned with a first light FOV for the first non-clinical FOV, acquire a second image of the one or more coins corresponding to a second non-clinical FOV, wherein the second non-clinical FOV has a second known target blade value, wherein for the second image the one or more coins are aligned with a second FOV for the second non-clinical FOV, determine positions of the one or more coins and positions of the plurality of collimator blades within the first and second images, determine positions of the first light FOV, the second light FOV, a first x-ray FOV for the first non-clinical FOV, and a second x-ray FOV for the second non-clinical FOV based on the positions of the one or more coins and the plurality of collimator blades, compare the positions of the first light FOV, the second light FOV, the first x-ray FOV for the first non-clinical FOV, and the second x-ray FOV to the respective known target blade values for each of the first and second non-clinical FOVs, determine, based on the comparison, a position of a third light FOV and a position of a third x-ray FOV for a clinical FOV, compute, based on the position of the third light FOV and the position of the third x-ray FOV, a first deviation between the third light FOV and the third x-ray FOV and a second deviation between the third x-ray FOV and an active area of the detector, compare the first and second deviations to respective threshold deviations for a selected standard, and in response to one or more of the first and second deviations exceeding a corresponding threshold deviation, outputting a notification of misalignment to a user. In a first example of the system to determine the positions of the one or more coins, the controller is configured to identify a center of each of the one or more coins. In a second example of the system, optionally including the first example, the first non-clinical FOV is smaller than the second non-clinical FOV and the clinical FOV is larger than the first non-clinical FOV and smaller than the second non-clinical FOV.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An x-ray system, comprising:
an x-ray source configured to emit an x-ray beam;
a detector configured to detect the x-ray beam;
a visible light;
a collimator comprising a plurality of collimator blades; and
a controller comprising one or more processors and memory storing instructions that when executed cause the one or more processors to:
acquire at least two images of one or more radiopaque objects positioned according to the visible light, wherein a first image is acquired according to a first x-ray field of view (FOV) with a first target blade value and a second image is acquired according to a second x-ray FOV with a second target blade value;
determine, for each of the at least two images, positions of the one or more radiopaque objects and the plurality of collimator blades;
determine positions of x-ray FOVs and light FOVs with respect to the first target blade value and the second target blade value based on the positions of the plurality of collimator blades and the one or more radiopaque objects;
determine positions of a third light FOV and a third x-ray FOV for a clinical FOV with a third target blade value based on the positions of the x-ray FOVs and light FOVs with respect to the first and second target blade values;
determine a first FOV alignment for the clinical FOV between the third light FOV and the third x-ray FOV and a second alignment for the clinical FOV between the third x-ray FOV and the detector; and
output the first and second alignment.

2. The x-ray system of claim 1, wherein, to detect the one or more radiopaque objects and the plurality of collimator blades, the controller is configured to, for each of the first and second images:
preprocess the image;
generate a gradient image from the preprocessed image;
determine localized edges based on the gradient image and the preprocessed image; and
generate a dissociated edge image based on the localized edges, wherein the dissociated edge image comprises dissociated edges belonging to the one or more radiopaque objects and edges belonging to the plurality of collimator blades.

3. The x-ray system of claim 2, wherein, to determine the positions of the one or more radiopaque objects, the controller is configured to, for each of the at least two images, perform circle detection and, to determine the positions of the one or more collimator blades, the controller is configured to, for each of the at least two images, perform line detection.

4. The x-ray system of claim 3, wherein, to perform circle detection, the controller is configured to:
generate a gradient direction image based on the gradient image;
determine one or more potential circle centers based on the dissociated edge image and the gradient direction image; and
identify a most likely center and radius for each of the one or more radiopaque objects.

5. The x-ray system of claim 4, wherein identifying the most likely center comprises applying accumulation thresholding and non-maxima suppression.

6. The x-ray system of claim 3, wherein, to perform line detection, the controller is configured to apply a RANdom Sample Consensus (RANSAC) algorithm.

7. The x-ray system of claim 1, wherein, to determine the first FOV alignment (light versus x-ray), the controller is configured to: determine a difference between the third light FOV position and the third x-ray FOV position of a determined FOV corresponding to the clinical FOV.

8. The x-ray system of claim 1, wherein, to determine the second alignment (x-ray versus detector), the controller is configured to determine a difference between the third x-ray FOV position and a position of a detector active area of a determined FOV corresponding to the clinical FOV.

9. The x-ray system of claim 1, wherein the x-ray system is a mammography system.

10. The x-ray system of claim 1, wherein the one or more radiopaque objects are coins.

11. A method for an x-ray system comprising an x-ray source, a detector, and a collimator with a plurality of collimator blades, comprising:
acquiring a first image and a second image of one or more radiopaque objects with the x-ray system for a first non-clinical field of view (FOV) and a second non-clinical FOV, respectively, wherein the first and second non-clinical FOVs have known target blade values;
determining, for each of the first and second images, positions of the one or more radiopaque objects and positions of the plurality of collimator blades;
determining, based on the positions of the one or more radiopaque objects and the positions of the plurality of collimator blades, a position of a light FOV and a position of an x-ray FOV for each of the first non-clinical FOV and the second non-clinical FOV;
determining a first relationship between the determined position of the light FOV and corresponding known target blade values of the first and second non-clinical FOV and a second relationship between the determined position of the x-ray FOV and the known target blade values of the first and second non-clinical FOV;
determining, based on the comparison, light FOV positions and x-ray FOV positions for one or more clinical FOVs; and
computing, based on the light FOV positions and the x-ray FOV positions, a first FOV alignment between the light FOV and the x-ray FOV and a second FOV alignment between the x-ray FOV and an active area of the detector.

12. The method of claim 11, wherein the one or more radiopaque objects are coins.

13. The method of claim 11, wherein determining the positions of the one or more radiopaque objects and the plurality of collimator blades comprises, for each of the first and second images:
smoothing the image;
generating a gradient image from the smoothed image;
determining localized edges based on the gradient image and the smoothed image; and
generating a dissociated edge image based on the localized edges, wherein the dissociated edge image comprises dissociated edges belonging to the one or more radiopaque objects and edges belonging to the plurality of collimator blades.

14. The method of claim 13, wherein determining the positions of the one or more radiopaque objects further comprises:
generating a gradient direction image based on the gradient image;
determining one or more potential circle centers based on the dissociated edge image and the gradient direction image; and
identifying a most likely center for each of the one or more radiopaque objects.

15. The method of claim 13, wherein determining the positions of the plurality of collimator blades further comprises, for a first collimator blade:
drawing a plurality of lines between pairs of pixels of the dissociated edge image; and
identifying a line of the plurality of lines with the most pixels in a vicinity of the line.

16. The method of claim 11, wherein computing the first FOV alignment comprises computing a difference between the light FOV position and the x-ray FOV position for the one or more clinical FOVs and wherein computing the second FOV alignment comprises computing a difference between the x-ray FOV position and a position of the active area of the detector for the one or more clinical FOVs.

17. The method of claim 11, wherein the x-ray system is a mammography system.

18. A mammography system, comprising:
an x-ray source configured to emit an x-ray beam;
a detector configured to detect the x-ray beam;
a visible light;
a collimator comprising a plurality of collimator blades; and
a controller comprising one or more processors and memory storing instructions that when executed cause the one or more processors to:
acquire a first image of one or more coins corresponding to a first non-clinical field of view (FOV), wherein the first non-clinical FOV has a first known target blade value, wherein for the first image the one or more coins are aligned with a first light FOV for the first non-clinical FOV;
acquire a second image of the one or more coins corresponding to a second non-clinical FOV, wherein the second non-clinical FOV has a second known target blade value, wherein for the second image the one or more coins are aligned with a second FOV for the second non-clinical FOV;
determine positions of the one or more coins and positions of the plurality of collimator blades within the first and second images;
determine positions of the first light FOV, the second light FOV, a first x-ray FOV for the first non-clinical FOV, and a second x-ray FOV for the second non-clinical FOV based on the positions of the one or more coins and the plurality of collimator blades;
compare the positions of the first light FOV, the second light FOV, the first x-ray FOV for the first non-clinical FOV, and the second x-ray FOV to the respective known target blade values for each of the first and second non-clinical FOVs;
determine, based on the comparison, a position of a third light FOV and a position of a third x-ray FOV for a clinical FOV;
compute, based on the position of the third light FOV and the position of the third x-ray FOV, a first deviation between the third light FOV and the third x-ray FOV and a second deviation between the third x-ray FOV and an active area of the detector;
compare the first and second deviations to respective threshold deviations for a selected standard; and
in response to one or more of the first and second deviations exceeding a corresponding threshold deviation, outputting a notification of misalignment to a user.

19. The mammography system of claim 18, wherein, to determine the positions of the one or more coins, the controller is configured to identify a center of each of the one or more coins.

20. The mammography system of claim 18, wherein the first non-clinical FOV is smaller than the second non-clinical FOV and the clinical FOV is larger than the first non-clinical FOV and smaller than the second non-clinical FOV.
